(19) United States
(12) Patent Application Publication
(10) Pub. No.: US 2010/0146375 A1
(43) Pub. Date: Jun. 10, 2010

(54) METHOD FOR PRODUCING SOUND OR VIDEO STREAMS, AND APPARATUS CONFIGURED THEREFOR

(76) Inventors: Darius Katz, Malmo (SE); Stefan Olsson, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/328,977

(22) Filed: Dec. 5, 2008

(51) Int. Cl. G06F 17/00

(52) U.S. Cl. 715/201

(57) ABSTRACT

A method of producing a sound or video stream is based on a so-called tweaky file and an original file. The tweaky file includes actions and time stamp(s) associated with each action. The original file includes sound or video content. An action is selected in the tweaky file. The time stamp(s) associated with the selected action is obtained from the tweaky file. The point or segment of the original file corresponding to the obtained time stamp(s) is identified. The selected action is executed on the identified point or segment. Then, the steps of selecting, obtaining, identifying and executing are repeated, for the next actions in the tweaky file, to produce the sound or video stream. The invention also relates to an apparatus, computer-readable medium, computer-readable file, signal and computer program.

### TECHNICAL FIELD

The present invention relates to a method for producing a sound or video stream. The invention also relates to an apparatus configured for producing a sound or video stream, to a computer-readable medium, a computer-readable file, a signal comprising such a computer-readable file and a computer program, in the technical field of producing and reproducing sound or video streams.

### BACKGROUND

Reproducing video or sound content often involves devices storing data representing the video or sound content and including means, such as electronic means, for transforming the data into images and/or sound using a video screen and/or a speaker. The data may represent the video or sound content in a digital, compressed form. For instance, MP3 is an audio encoding format and MP3 files may be used on the above devices for reproducing sound, such as music. Such files can be purchased and stored on portable or non-portable devices, such as devices including a media player software, for reproducing later the file content.

It is desirable to provide methods, apparatuses and computer programs to improve the reproduction and production of sound or video streams, notably by allowing more flexibility regarding what is reproduced. It is also desirable to provide such methods, apparatuses and computer programs without increasing the hardware and memory needs and the implementation complexity, and without sacrificing the user interface simplicity.

### SUMMARY

Such methods, apparatuses and computer programs are defined in the independent claims. Advantageous embodiments are defined in the dependent claims.

In one embodiment, the method is a method for producing a sound or video stream. Such method is based on a file including an ordered list of actions and at least one time stamp associated with each action, the file being herein referred to as tweaky file, and on a file including sound or video content, the file being herein referred to as original file. The method includes the steps of selecting an action in the tweaky file; obtaining, from the tweaky file, the at least one time stamp associated with the selected action; identifying the point or segment of the original file corresponding to the obtained at least one time stamp; executing the selected action on the identified point or segment; and repeating, for the next actions in the tweaky file, the steps of selecting, obtaining, identifying and executing, to produce the sound or video stream.

The method enables users to modify the video or sound content on their reproducing devices, without modifying the original file. This reduces the memory used for storing the content. Indeed, only the original file and the tweaky file are stored, rather than the original file and the modified version of the original file. In addition, no modified version of the original file is stored on the reproducing device, thus reducing the risk of copyright infringement caused by the existence of the modified version of the original file on the reproducing device.

The original and tweaky files are synergistically merged into a video or sound stream for outputting video or sound content in a personalized manner. This advantage is provided without excessively increasing the memory resources for storing the personalized, tweaked version. Herein, “to tweak” means to modify in a personalized manner, to make adjustment to.

A time stamp is a reference to a particular point, i.e. a particular moment, in the original file. Two time stamps enable to identify a particular segment in the original file, between two moments.

In one embodiment, an action in the tweaky file includes at least one of cutting a segment, repeating a segment, duplicating a segment, playing a segment at a higher speed, playing a segment at a lower speed, changing the volume at one point of the sound content, and changing the color at one point of the video content.

These actions enable the personalization and tweaking of the content with as much flexibility as possible. The types of actions which can be recorded in the tweaky file are not however limited by the above-referred actions.

In one embodiment, the tweaky file does not contain media content of the original file. This enables the clear separation between original, possibly copyrighted content and personalized modifications to the content.

In one embodiment, the method neither includes creating nor storing a modified version of the original file. At no time in the execution of the method according to this embodiment, a modified version of the original file exists in the apparatus on which the method is carried out. Only the personalized manner according to which the video or sound content is reproduced is stored in the tweaky file.

The invention also relates to an apparatus configured for producing a sound or video stream. The apparatus includes, or is configured to include, a file including an ordered list of actions and at least one time stamp associated with each action, the file being herein referred to as tweaky file; and a file including sound or video content, the file being herein referred to as original file. The apparatus includes, or further includes, a selector configured for selecting an action in the tweaky file; an obtainer configured for obtaining, from the tweaky file, the at least one time stamp associated with the selected action; an identifier configured for identifying the point or segment of the original file corresponding to the obtained at least one time stamp; an executer configured for executing the selected action on the identified point or segment; and a repeater configured for repeating, for the next actions in the tweaky file, the operations that the selector, obtainer, identifier and executer are configured to carry out, to produce the sound or video stream.

In one embodiment, the apparatus is such that an action in the tweaky file includes at least one of cutting a segment; repeating a segment; duplicating a segment; playing a segment at a higher speed; playing a segment at a lower speed; changing the volume at one point of the sound content; and changing the color at one point of the video content.

In one embodiment, the apparatus is such that the tweaky file does not contain media content of the original file.

In one embodiment, the apparatus is configured neither for creating nor storing a modified version of the original file.

The invention also relates to a computer-readable medium which comprises a computer-readable file including an ordered list of actions and at least one time stamp associated with each action, the file being herein referred to as tweaky file; and a computer-readable file including sound or video content, the file being herein referred to as original file. The apparatus further includes computer-readable instructions configured, when executed on an apparatus, to cause the apparatus to select an action in the tweaky file; obtain, from the tweaky file, the at least one time stamp associated with the selected action; identify the point or segment of the original file corresponding to the obtained at least one time stamp; execute the selected action on the identified point or segment; and repeat, for the next actions in the tweaky file, the steps of selecting, obtaining, identifying and executing, to produce the sound or video stream.

In one embodiment, the computer-readable medium is such that an action in the tweaky file includes at least one of cutting a segment; repeating a segment; duplicating a segment; playing a segment at a higher speed; playing a segment at a lower speed; changing the volume at one point of the sound content; and changing the color at one point of the video content.

In one embodiment, the computer-readable medium is such that tweaky file does not contain media content of the original file.

In one embodiment, the computer-readable medium is such that the computer-readable instructions are configured to cause the apparatus neither to create nor store a modified version of the original file.

The invention also relates to a computer-readable file including an ordered list of actions and at least one time stamp associated with each action, the file being adapted for use as a tweaky file in one of the above-mentioned apparatuses.

The invention also relates to a computer-readable file including an ordered list of actions and at least one time stamp associated with each action, the file being adapted for use as a tweaky file in an apparatus as described above.

The invention also relates to a computer-readable file including an ordered list of actions and at least one time stamp associated with each action, the file being adapted for use as a tweaky file in the above-described apparatus, wherein an action in the tweaky file includes at least one of, but is not limited to, cutting a segment; repeating a segment; duplicating a segment; playing a segment at a higher speed; playing a segment at a lower speed; changing the volume at one point of the sound content; and changing the color at one point of the video content.

The invention also relates to a signal comprising any one of the above-described computer-readable files. The transport on a signal, such as a digital or analog signal, which may be an electromagnetic signal, of the tweaky file is particularly advantageous to efficiently (i.e. without requiring excessive bandwidth) exchange personalized, or tweaked, ways of reproducing video on sound content.

The invention also relates to a computer program configured, when executed on an apparatus, to cause the apparatus to carry out any one of the above-described method.

### BRIEF DESCRIPTION OF THE DRAWINGS

Embodiments of the present invention shall now be described, in conjunction with the appended figures, in which:

FIG. 1 illustrates a flow chart of a method according to one embodiment of the invention;

FIG. 2 schematically illustrates an exemplary tweaky file, an exemplary original file, and an exemplary reproducing output which can occur in time; and

FIG. 3 schematically illustrates an apparatus according to one embodiment of the invention.

### DETAILED DESCRIPTION

The present invention shall now be described in conjunction with specific embodiments. It may be noted that these specific embodiments serve to provide the skilled person with a better understanding, but are not intended to in any way restrict the scope of the invention, which is defined by the appended claims.

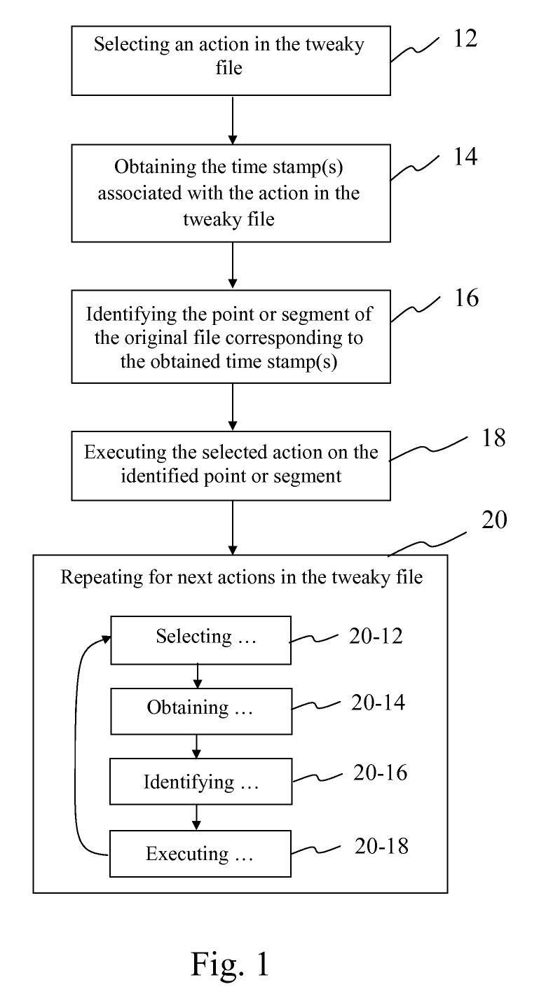

FIG. 1 schematically illustrates a flow chart of a method according to one embodiment of the invention. The flow chart shows a series of successive steps intended to be carried out sequentially.

The method is carried out by an apparatus 100 comprising a processing unit and is carried out with or without the intervention of a human user. That is, the method may be either carried out by a computer or the like, or by a computer with the assistance of a human user.

First, an action is selected 12 in the tweaky file 30. More specifically, in the illustrated embodiment, the first action in the ordered list of actions of the tweaky file 30 is selected. Then, the time stamp(s) associated with the action in the tweaky file 30 is/are obtained 14.

The point corresponding to the obtained time stamp or the segment corresponding to the obtained time stamps is identified 16 in the original file 40. The selected action is then executed 18 on the identified point or segment of the original file 40. For instance, the execution 18 of an action may lead to playing back a segment of the original file, skipping or cutting a segment, repeating a segment, changing the characteristics, such as the volume, the colour characteristics, or brightness characteristics, of the sound or image of the original file 40, and the like.

Afterwards, for the next actions listed in the tweaky file 30, the steps of selecting 20-12, obtaining 20-14, identifying 20-16, and executing 20-18 are repeated 20. The successive execution 18, 20-18 of the actions as listed in the tweaky file 30 leads to the production of a sound or video stream 50 which is personalized according to the content of the tweaky file 30.

The flow chart of FIG. 1 illustrates the method in two groups of steps. The first group of steps 12, 14, 16 and 18 are performed for the first action in the tweaky file 30. The second group of steps is the repetition 20 of the steps 20-12, 20-14, 20-16 and 20-18. The representation into two groups of steps is made for clarity only, and, in one embodiment, the method is implemented with only one group of steps repeated for each action in the tweaky file 20 using for instance a “for loop”, a “while loop”, or a “do while loop”. Any other computer programming control flow statement allowing code to be executed repeatedly based on the existence of still an action in the tweaky file 30 may also be used.

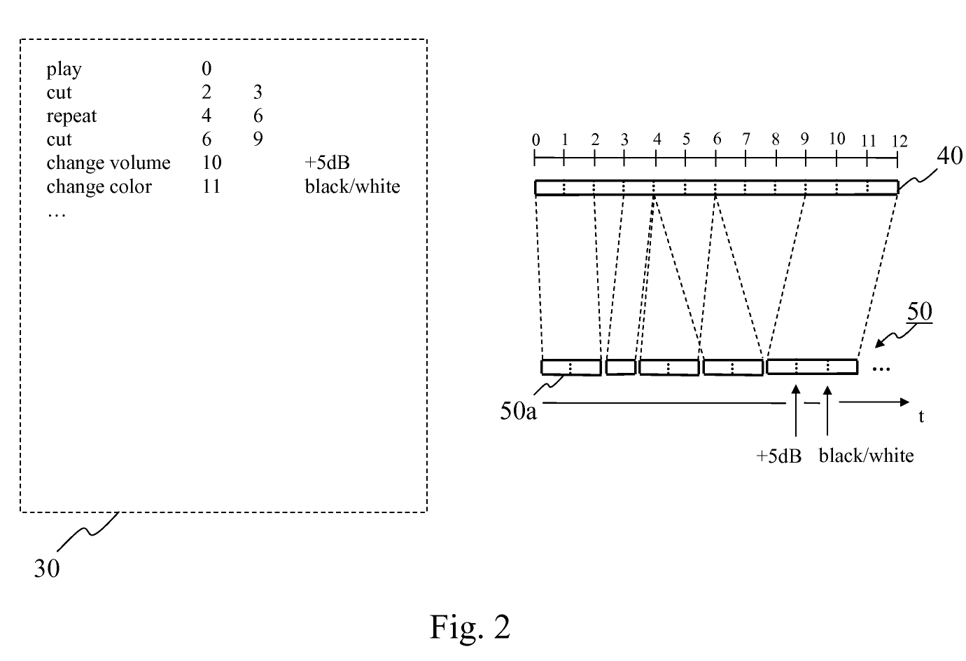

FIG. 2 schematically illustrates, on the left-hand side, the exemplary content of a tweaky file 30, and, on the right-hand side, an exemplary original file 40 as well as the production of a sound or video stream 50 based on the actions contained in the tweaky file 30 and based on the original file 40.

As illustrated, the exemplary tweaky file 30 includes a series of successive lines, each referring to an action (“play”, “cut”, “repeat”, “cut”, “change volume”, etc), at least one time stamp (the first line contains one time stamp, namely “0”, the second line contains two time stamps, namely “2” and “3”, the third line contains two time stamps “4” and “6”, etc) and optionally one or more parameters associated with the action.

The tweaky file 30 may include some random tweaking actions causing the video or sound stream 50 to be different each time the tweaky file 30 is applied to the original file 40. In one embodiment, the tweaky file 30 may be dynamically updated by the user when the method has already started to produce the stream 50. A user interface may be used to create or modify the tweaky file 30.

On the right-hand side, top part, of FIG. 2, an exemplary original file 40 is schematically represented. The original file 40 includes twelve segments. This number of segments is only an example and more or less segments may compose an original file 40. The organisation of the original file 40 into segments is also an exemplary type of organisation of the original file 40. Embodiments of the invention may be carried out without using any kind of segmentation of the original file 40. That is, an original file 40 bearing no segmentation but wherein each time stamp correspond to a particular duration from the start of the original file 40 to a certain point may be used.

The method according to one embodiment of the invention making use of the tweaky file 30 and the original file 40 is illustrated on the right-hand side of FIG. 2. First, an action is selected 12 in the tweaky file 30. That is, the action “play” is selected. Then, the at least one time stamp associated with the selected action “play” is obtained 14 from the tweaky file 30. That is, the time stamp “0” is obtained. The point corresponding to the time stamp “0” is then identified 16 in the original file 40. The selected action “play” is finally executed 18 on the identified time stamp “0”. The produced video or sound stream segment resulting from this process is referred to in FIG. 2 by reference 50a.

The next action, namely the action “cut”, is then selected 12. The time stamps “2” and “3” are obtained 14 from the tweaky file 30. The segment corresponding to the time stamps “2” and “3” are identified 16 in the original file 40, and, finally, the selected action, namely the action “cut”, is executed 18 on the identified segment from the time stamp “2” to the time stamp “3”. As a result, the production of the video or sound stream 50 directly jumps to the fourth segment (between the references “3” and “4”), skipping the third segment between the points “2” and “3”.

Likewise, the process is repeated 20 for all subsequent actions listed in the tweaky file 30. Between the different produced segments of the video or sound stream 50 as illustrated on the right-hand side, bottom part, of FIG. 2 small gaps are illustrated. This is only a drawing artefact for clarity, which does not mean that there is an interruption in the production of the video or sound stream 50. Furthermore, the complete video or sound stream 50 represented in FIG. 2 does not exist at any time in memory. What is illustrated is only a representation in time of the production output of the tweaking process. That is, in one embodiment the modified file corresponding to the video or sound stream 50 is not stored in memory. In another embodiment however, the apparatus 100 implementing the method according to the invention is capable of creating a modified version of the original file and of storing it in memory.

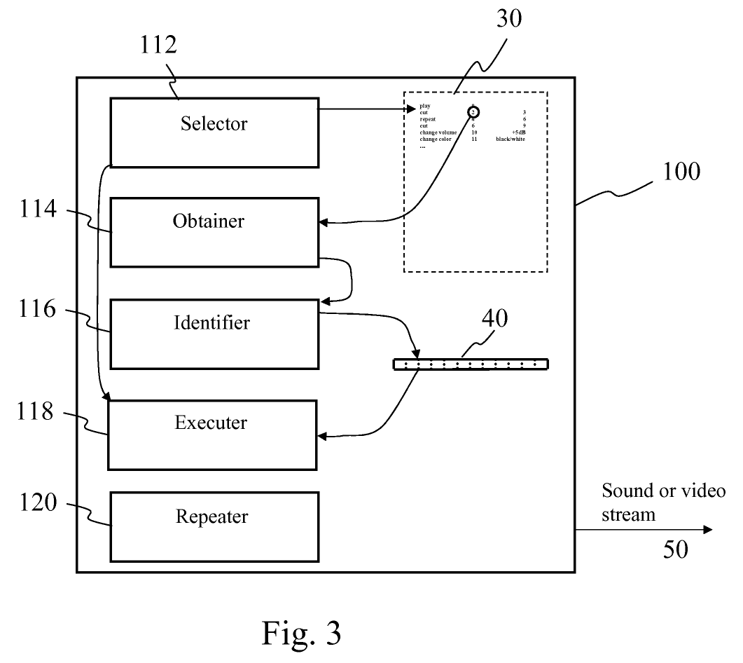

FIG. 3 schematically illustrates an apparatus 100 according to one embodiment of the invention. The apparatus 100 is configured to include or store a tweaky file 30 and an original file 40. Furthermore, an apparatus 100 includes a selector 112, an obtainer 114, an identifier 116, an executer 118 and a repeater 120. The tweaky file 30 includes an ordered list of actions, or references to actions, and at least one time stamp associated with each action. The original file 40 includes sound or video content, or bytes representing sound or video content. The selector 112 is configured for selecting an action in the tweaky file 30, as illustrated by the arrow originating from the box labelled “selector” to the tweaky file 30.

The obtainer 114 is configured for obtaining, from the tweaky file 30, the at least one time stamp associated with the selected action. This operation is represented by the arrow originating from the column of time stamps in the tweaky file 30 to the obtainer 114.

The identifier 116 is configured for identifying the point or segment of the original file 40 corresponding to the obtained at least one time stamp. The arrow originating from the obtainer 114 and leading to the identifier 116 schematically represents the provision by the obtainer 114 to the identifier 116 of the at least one time stamp. The arrow originating from the identifier 116 pointing to the original file 40 schematically represents the operation consisting in pointing and identifying the point or segment corresponding to the time stamp(s) in the original file 40.

The executor 118 is configured for executing the selected action on the identified point or segment. This process, which is repeated by the repeater 120 for each successive action listed in the tweaky file 30, leads to the production of a sound of video stream 50.

The physical entities according to the invention, including the apparatuses may comprise or store computer programs including instructions such that, when the computer programs are executed on the physical entities, steps and procedures according to embodiments of the invention are carried out. The invention also relates to such computer programs for carrying out methods according to the invention, and to any computer-readable medium storing the computer programs for carrying out methods according to the invention.

Where the terms “selector”, “obtainer”, “identifier”, “executer”, and “repeater” are used herewith, no restriction is made regarding how distributed these elements may be and regarding how gathered elements may be. That is, the constituent elements of the above selector, obtainer, identifier, executer, and repeater may be distributed in different software or hardware components or devices for bringing about the intended function. A plurality of distinct elements may also be gathered for providing the intended functionalities.

Any one of the above-referred elements of an apparatus may be implemented in hardware, software, field-programmable gate array (FPGA), application-specific integrated circuit (ASICs), firmware or the like.

In further embodiments of the invention, any one of the above-mentioned and/or claimed selector, obtainer, identifier, executer, and repeater is replaced by selecting means, obtaining means, identifying means, executing means and repeating means respectively, or by a selecting unit, an obtaining unit, an identifying unit, an executing unit, and a repeating unit respectively, for performing the functions of the selecting means, obtaining means, identifying means, executing means and repeating means.

In further embodiments of the invention, any one of the above-described steps may be implemented using computer-readable instructions, for instance in the form of computer-understandable procedures, methods or the like, in any kind of computer languages, and/or in the form of embedded software on firmware, integrated circuits or the like.

Although the present invention has been described on the basis of detailed examples, the detailed examples only serve to provide the skilled person with a better understanding, and are not intended to limit the scope of the invention. The scope of the invention is much rather defined by the appended claims.

1. Method of producing a sound or video stream based on
a file including an ordered list of actions and at least one time stamp associated with each action, the file being herein referred to as tweaky file, and
a file including sound or video content, the file being herein referred to as original file;
the method including the steps of
selecting an action in the tweaky file;
obtaining, from the tweaky file, the at least one time stamp associated with the selected action;
identifying the point or segment of the original file corresponding to the obtained at least one time stamp;
executing the selected action on the identified point or segment; and
repeating, for the next actions in the tweaky file, the steps of selecting, obtaining, identifying and executing, to produce the sound or video stream.

2. Method of claim 1, wherein an action in the tweaky file includes at least one of
cutting a segment;
repeating a segment;
duplicating a segment;
playing a segment at a higher speed;
playing a segment at a lower speed;
changing the volume at one point of the sound content; and
changing the color at one point of the video content.

3. Method of claim 1, wherein the tweaky file does not contain media content of the original file.

4. Method according to claim 1, wherein the method does not include creating nor storing a modified version of the original file.

5. Apparatus configured for producing a sound or video stream and configured for including:
a file including an ordered list of actions and at least one time stamp associated with each action, the file being herein referred to as tweaky file; and
a file including sound or video content, the file being herein referred to as original file;
the apparatus including:
a selector configured for selecting an action in the tweaky file;
an obtainer configured for obtaining, from the tweaky file, the at least one time stamp associated with the selected action;
an identifier configured for identifying the point or segment of the original file corresponding to the obtained at least one time stamp;
an executer configured for executing the selected action on the identified point or segment; and
a repeater configured for repeating, for the next actions in the tweaky file, the operations that the selector, obtainer, identifier and executer are configured to carry out, to produce the sound or video stream.

6. Apparatus of claim 5, wherein an action in the tweaky file includes at least one of
cutting a segment;
repeating a segment;
duplicating a segment;
playing a segment at a higher speed;
playing a segment at a lower speed;
changing the volume at one point of the sound content; and
changing the color at one point of the video content.

7. Apparatus of claim 5, wherein the tweaky file does not contain media content of the original file.

8. Apparatus according to claim 5, the apparatus being configured neither for creating nor storing a modified version of the original file.

9. Computer-readable medium comprising
a computer-readable file including an ordered list of actions and at least one time stamp associated with each action, the file being herein referred to as tweaky file;
a computer-readable file including sound or video content, the file being herein referred to as original file;
computer-readable instructions configured, when executed on an apparatus, to cause the apparatus to
select an action in the tweaky file;
obtain, from the tweaky file, the at least one time stamp associated with the selected action;
identify the point or segment of the original file corresponding to the obtained at least one time stamp;
execute the selected action on the identified point or segment; and
repeat, for the next actions in the tweaky file, the steps of selecting, obtaining, identifying and executing, to produce the sound or video stream.

10. Computer-readable medium of claim 9, wherein an action in the tweaky file includes at least one of
cutting a segment;
repeating a segment;
duplicating a segment;
playing a segment at a higher speed;
playing a segment at a lower speed;
changing the volume at one point of the sound content; and
changing the color at one point of the video content.

11. Computer-readable medium of claim 9, wherein the tweaky file does not contain media content of the original file.

12. Computer-readable medium according to claim 9, wherein the computer-readable instructions are configured to cause the apparatus neither to create nor store a modified version of the original file.

13. Computer-readable file including an ordered list of actions and at least one time stamp associated with each action, the file being adapted for use as a tweaky file in an apparatus of claim 5.

14. Computer-readable file including an ordered list of actions and at least one time stamp associated with each action, the file being adapted for use as a tweaky file in an apparatus of claim 5, wherein an action in the tweaky file includes at least one of
cutting a segment;
repeating a segment;
duplicating a segment;
playing a segment at a higher speed;
playing a segment at a lower speed;
changing the volume at one point of the sound content; and
changing the color at one point of the video content.

15. Signal comprising a computer-readable file of claim 13.

16. Computer program configured, when executed on an apparatus, to cause the apparatus to carry out a method according to claim 1.
